(19) United States
(12) Patent Application Publication
(10) Pub. No.: US 2008/0170799 A1
(43) Pub. Date: Jul. 17, 2008

(54) METHOD FOR CALIBRATING A RESPONSE CURVE OF A CAMERA

(75) Inventors: Wen-Chao Chen, Kaohsiung City (TW); Cheng-Yuan Tang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/944,414

(22) Filed: Nov. 22, 2007

(30) Foreign Application Priority Data
Jan. 11, 2007 (TW) 96101767

(51) Int. Cl. G06K 9/40

(52) U.S. Cl. 382/274

(57) ABSTRACT

A method for calibrating a response curve of a camera is provided. A homography relationship of an image sequence captured by the camera is calculated using a coplanar information including feature correspondence blocks of the image sequence. An intensity mapping function is then obtained from the intensity information of the correspondence blocks according to the homography relationship. The calculation for obtaining the intensity mapping function is significantly reduced by focusing on the correspondence blocks, which can also avoid the problem of outliers.

### CROSS-REFERENCE TO RELATED APPLICATION

This application claims the priority benefit of Taiwan application serial no. 96101767, filed Jan. 17, 2007. All disclosure of the Taiwan application is incorporated herein by reference.

### BACKGROUND OF THE INVENTION

1. Field of the Invention

The present invention relates to a method for processing a response curve of a camera.

2. Description of Related Art

Nowadays, even though cameras (or video cameras) have been developed rapidly along with the advancement of technologies, only a portion of a dynamic range of an actual scene can be captured. Thus, when a scene of high dynamic range is to be captured, a plurality of images of various exposures are usually captured for restoring a non-linear response curve of the camera, and further for obtaining a high dynamic range image. However, the conventional method for constructing high dynamic range image has many limitations, for example, the camera has to be fixed while being used for capturing images, and the scene has to be assumed to be static. Such limitations bring a lot of inconvenience in actual operation. For example, with such method, the camera has to be fixed on a tripod by experienced person. Besides, the assumption of a static scene is not acceptable if the purpose of capturing high dynamic range image is for security monitoring.

In the U.S. Pat. No. 6,912,324, a look-up table containing pre-computed fusion functions is established. Images of various exposures are fused through table look-up. The method for fusing the images includes summing, averaging, or Laplacian operation etc. This invention is only applicable to such case that the response curve of the camera is already known for pre-computed functions are used therein. Besides, this invention is only applicable to static cameras.

In U.S. Pat. No. 6,914,701, a dynamic range is defined as a signal-to-noise ratio (S/N ratio), and the dynamic range is increased by reducing noise. The noise at a high intensity part of an image is reduced by using two images of different exposures. The noise at a low intensity part of an image is reduced by performing multiple sampling in images of the same exposure. This invention is directed to capturing images of various exposures to a negative but not to an actual scene.

In U.S. Pat. No. 5,224,178, the dynamic range of a existing image in an image database is increased. The image is re-scanned so that the original image range 0˜255 is converted into 30˜225, so that room for adjustment of the bright and dark portions of the image are increased. According to this invention, the data range of the original image is compressed through image processing in order to increase subsequent processing room of the image. This invention does not provide a method for effectively expanding the dynamic range of an image.

Moreover, in the article “Radiometric Self-Alignment of Image Sequence” (CVPR'04) published by Kim, Pollefeys, and so on in 2004, relationships between images are established according to epipolar geometry theory, and the method is applicable to non-static cameras, and furthermore, it is not necessary to assume that the scene is static. However, according to the technique provided by this article, all the points in the images are used for calculating the intensity mapping function, thus, many outliers will be produced while calculating the intensity mapping function. This method increases the complexity of calculation. Besides, since all the points, including incorrect points, are used for calculating the intensity mapping function in this method, the accuracy of the calculation result is reduced.

### SUMMARY OF THE INVENTION

The present invention is directed to a method for calibrating a response curve of a camera, in which feature correspondence blocks of an image sequence are established using a homography relationship of the image sequence, and an intensity mapping function is then obtained from the intensity information of the feature correspondence blocks.

The present invention provides method for calibrating a response curve of a camera, in which the calculation for obtaining the intensity mapping is focused on particular regions instead of using the intensity of each point in the images, so that errors caused by quantization while calculating the intensity mapping function can be reduced.

According to a method for calibrating a response curve of a camera provided by the present invention, an image sequence composed of a plurality of images captured by various exposures is captured. A homography relationship of the image sequence is calculated according to selected feature correspondence blocks. An intensity mapping function of the image sequence is then calculated, and the response curve of the camera is calibrated according to the intensity mapping function.

According to a method for calibrating a response curve of a camera provided by the present invention, an image sequence composed of a plurality of images captured by various exposures is captured. A homography relationship of the image sequence is established by using a coplanar object information in the scene. A plurality of feature correspondence blocks of the image sequence is then established according to the homography relationship. An intensity mapping function of the image sequence is obtained by calculating the intensity information of the correspondence blocks, and accordingly the response curve of the camera is obtained.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for effectively calibrating a response curve of a non-static camera according to an embodiment of the present invention.

FIG. 2 is a diagram illustrating the relationship between various images of different exposures captured by a non-static camera according to an embodiment of the present invention.

FIG. 3 is a diagram illustrating correct exposures corresponding to various gray values according to an embodiment of the present invention.

FIG. 4 is a flowchart illustrating the steps for calculating a homography relationship of an image sequence according to an embodiment of the present invention.

FIGS. 5A˜5B are diagrams illustrating the feature points obtained according to the homography relationship in FIG. 4.

FIG. 6 is a flowchart illustrating the steps for obtaining an intensity mapping function of an image sequence by calculating the intensity information of the image sequence according to an embodiment of the present invention.

FIGS. 7A˜7B illustrate selected blocks and correspondence blocks of various images according to an embodiment of the present invention.

FIG. 8 illustrates an intensity mapping diagram obtained after establishing the intensity information of each point in correspondence blocks between two images according to an embodiment of the present invention.

FIG. 9A is diagram illustrating a histogram analysis for calculating an intensity mapping function according to an embodiment of the present invention, and FIG. 9B is a diagram illustrating the result obtained from FIG. 9A.

FIG. 10 illustrates an intensity mapping function obtained according to the conventional technique provided by Kim etc.

### DESCRIPTION OF EMBODIMENTS

The present invention provides a method for effectively calibrating a response curve of a non-static camera. First, an image sequence according to a plurality of images captured by various exposures is obtained using the non-static camera. A homography relationship of the image sequence is then established by using the coplanar object information in the scene. After that, feature correspondence blocks of the image sequence are established according to the homography relationship. An intensity mapping function of the image sequence is estimated through, for example, robust estimation, using the intensity information of the correspondence blocks, and further the response curve of the camera is obtained accordingly.

Since a non-static camera is used in the method, namely, the response curve of the camera is calibrated with images from difference views, the present invention is applicable to response curve calibration of multi-view camera systems.

According to the method for effectively calibrating a response curve of a non-static camera in the present invention, a non-static camera (or video camera) is used for obtaining an image sequence of various exposures, and it is not necessary to assume that all the objects in the scene are static to calibrate a response curve of the camera. A coplanar object can be easily found in a scene, thus, in the present invention, correspondence blocks between images captured by different exposures are constructed according to geometrical features of the coplanar object. An intensity mapping function of the image sequence is then established through analysis of the intensity information of the correspondence blocks, and the response curve of the camera is calibrated accordingly.

The method for effectively calibrating a response curve of a non-static camera in the present invention can provide a more accurate result compared to conventional techniques. Besides, it is not necessary to use a tripod or to assume the scene is static while capturing an image sequence of various exposures using a non-static camera, accordingly, the method for effectively calibrating a response curve of a non-static camera in the present invention provides convenience in using the non-static camera.

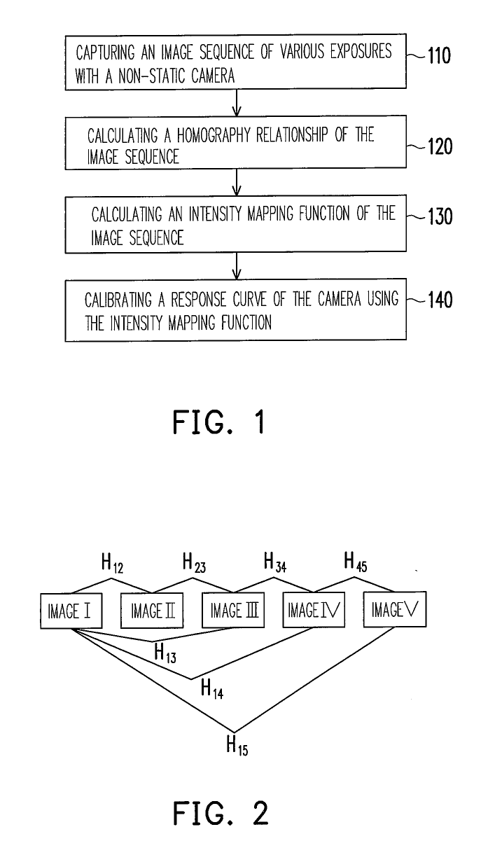

Below, the method for effectively calibrating a response curve of a non-static camera will be described with an embodiment of the present invention. FIG. 1 is a flowchart illustrating a method for effectively calibrating a response curve of a non-static camera according to an embodiment of the present invention. Referring to FIG. 1, first, in step 110, an image sequence composed of a plurality of images captured by various exposures are obtained by a non-static camera. The number of images in the image sequence is determined according to design requirement. After that, in step 120, a homography relationship of the image sequence is calculated. Feature correspondence blocks of the image sequence can be established according to the homography relationship. Thereafter, in step 130, an intensity mapping function of the image sequence is estimated using the intensity information of the correspondence blocks. Next, in step 140, a response curve of the camera is further obtained using the intensity mapping function.

The method for effectively calibrating a response curve of a non-static camera will be described with an embodiment of the present invention. Referring to FIG. 2, first, an image sequence I₁, I₂, I₃ . . . and Iₙ of various exposures is captured using a non-static camera, and the corresponding exposures thereof are E₁, E₂, E₃ . . . and Eₙ. Here image I, image II, image III, image IV, and image V are used for describing the present embodiment; however, the present invention is not limited thereto.

The internal geometric projection relationship between any two images is referred to as epipolar geometry, and which is not related to the shape and color of the object in the images but is related mainly to internal and external factors of the camera. When coplanar correspondence points in 3D space are projected on 2D images, the correspondence points in two captured images have a geometric projection relationship. A homography relationship can be deduced from the coplanar correspondence points. The homography relationships between image I, image II, image III, image IV, and image V in FIG. 2 is as illustrated in the figure, which include H₁₂, H₂₃, H₃₄, H₄₅, H₁₃, H₁₄, and H₁₅, wherein H_{XY} represents the homography information between image X and image Y.

Thus, the homography information between images can be established using a coplanar object in the scene. This step is like performing image registration to the image sequence. The 2D coordinates of a particular point in 3D space on various images can be obtained through homography conversion. Since every image has different exposure, the particular point in 3D space presents different brightness on these images. Thus, an intensity mapping exists between every two images. For example, a point having gray value B₁ in image I has gray value B₂ in image II, and each image pair has such intensity mapping:

B₂=π(B₁), wherein π is the intensity mapping function.

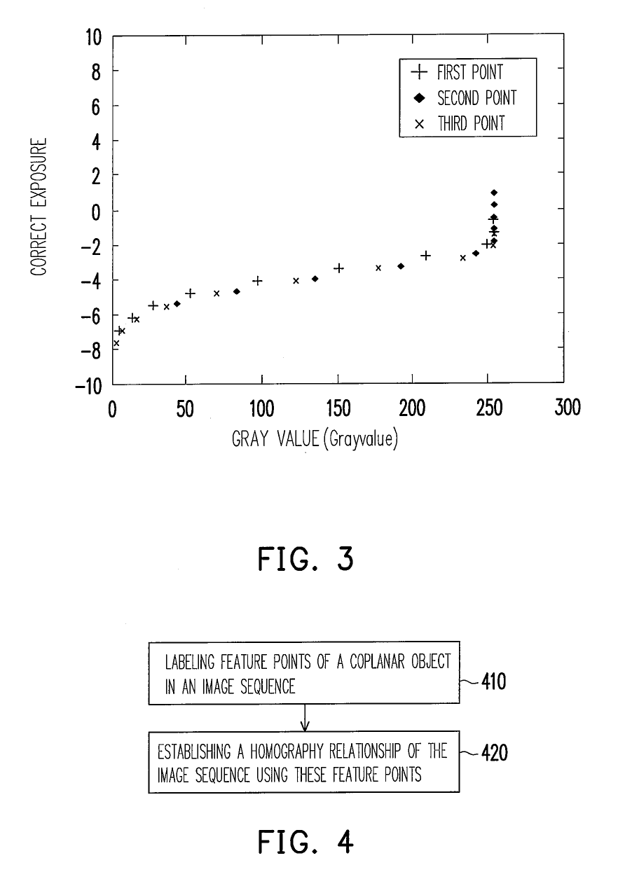

Eventually, a camera response curve covering various exposures can be obtained through the intensity mapping function between the images. As shown in FIG. 3, curves of various points, such as the first point, the second point, and the third point in FIG. 3, can be obtained from correct exposures corresponding to various gray values on axis X.

### Calculating the Homography Relationship

FIG. 4 is a flowchart illustrating the steps for calculating a homography relationship of an image sequence according to an embodiment of the present invention. First, feature points of a coplanar object in the scene are labeled in the image sequence as in step 410. The geometric projection relationship between two images is referred to as epipolar geometry, and which is not related to the shapes and colors of objects in the images but is related mainly to internal and external factors of the camera. While coplanar correspondence points in 3D space are projected on 2D images, the correspondence points in two images have a geometric projection relationship. Thus, the feature points of the coplanar object in the scene can be labeled in the images of the image sequence. Next, in step 420, the homography relationship of the image sequence is deduced using these coplanar correspondence points.

The procedure illustrated in FIG. 4 includes following two step:

The first step is to labeling the feature points of a coplanar object.

At least 4 feature points are required for calculating the homography relationship between two images; however, the number of feature points can be adjusted according to design requirement. Correspondence points on a coplanar object may be selected manually, or, the feature points on a coplanar object in the scene may also be located automatically through plane fitting and feature tracking.

The second step is to establish the homography relationship using these feature points.

When the coplanar correspondence points in 3D space are projected on 2D images, the correspondence points in two images have a geometric projection relationship (x′=Hx), wherein x and x′ are correspondence points in two images. A homography matrix H is then deduced from the coplanar correspondence points, wherein H may be a 3×3 matrix.

The deduction is as following:

First,

$$[ \begin{matrix}{u}^{′} \\ {v}^{′} \\ 1\end{matrix} ] = ⌊ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ⌋ [ \begin{matrix}u \\ v \\ 1\end{matrix} ]$$

wherein [u,v] and [u′,v′] are the coordinates of the correspondence points of a coplanar point in 3D space projected on a first image and a second image.

The expression is expanded as following:

$$[ \begin{matrix}{u}^{′} \\ {v}^{′}\end{matrix} ] = [ \begin{matrix}\frac{{h}_{11} u + {h}_{12} v + {h}_{13}}{{h}_{31} u + {h}_{32} v + {h}_{33}} \\ \frac{{h}_{21} u + {h}_{22} v + {h}_{23}}{{h}_{31} u + {h}_{32} v + {h}_{33}}\end{matrix} ]$$

$${h}_{11} u + {h}_{12} v + {h}_{13} - {h}_{31} {uu}^{′} - {h}_{32} {vu}^{′} - {h}_{33} {u}^{′} = 0$$

$${h}_{21} u + {h}_{22} v + {h}_{23} - {h}_{31} {uv}^{′} - {h}_{32} {vv}^{′} - {h}_{33} {v}^{′} = 0$$

$$Then , \\ {{[ \begin{matrix}{u}_{1} & {v}_{1} & 1 & 0 & 0 & 0 & - {u}_{1} {u}_{1}^{′} & - {v}_{1} {u}_{1}^{′} & - {u}_{1}^{′} \\ 0 & 0 & 0 & {u}_{1} & {v}_{1} & 1 & - {u}_{1} {v}_{1}^{′} & - {v}_{1} {v}_{1}^{′} & - {v}_{1}^{′} \\ ⋮ & ⋮ & ⋮ & ⋮ & ⋮ & ⋮ & ⋮ & ⋮ & ⋮ \\ {u}_{n} & {v}_{n} & 1 & 0 & 0 & 0 & - {u}_{n} {u}_{n}^{′} & - {v}_{n} {u}_{n}^{′} & - {u}_{n}^{′} \\ 0 & 0 & 0 & {u}_{n} & {v}_{n} & 1 & - {u}_{n} {v}_{n}^{′} & - {v}_{n} {v}_{n}^{′} & - {v}_{n}^{′}\end{matrix} ]}_{n \times 9} [ \begin{matrix}{h}_{11} \\ {h}_{12} \\ {h}_{13} \\ {h}_{21} \\ {h}_{22} \\ {h}_{23} \\ {h}_{31} \\ {h}_{32} \\ 1\end{matrix} ]}_{9 \times 1} = {[ \begin{matrix}0 \\ 0 \\ ⋮ \\ 0 \\ 0\end{matrix} ]}_{n \times 1}$$

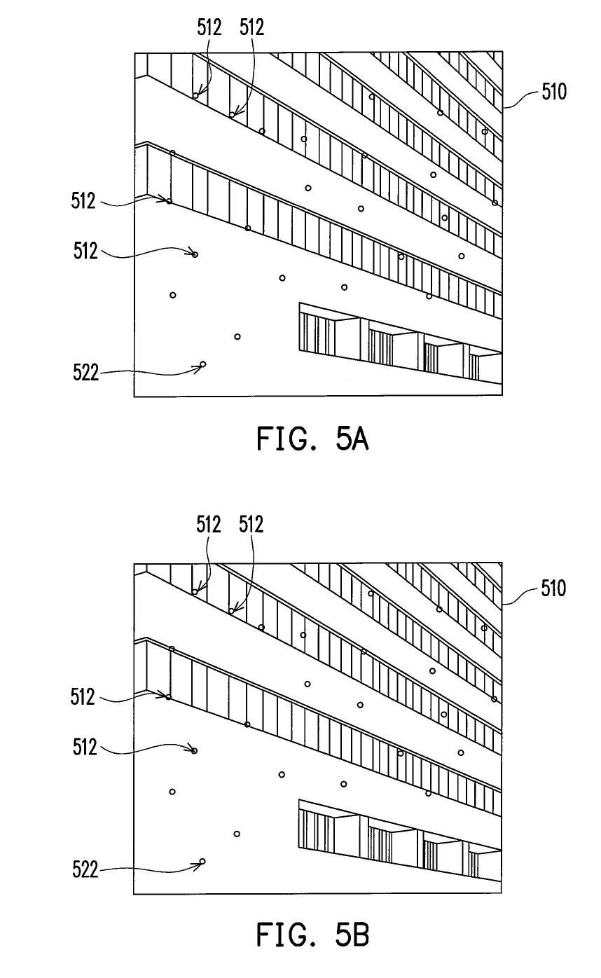

It can be understood from foregoing expression that 2 formulas are produced from one group of correspondence points, thus, at least 4 groups of correspondence points are required from obtaining the homography matrix H. After the homography matrix H is obtained, the coordinates in the first image are brought into expression xᵢ′=Hxᵢ (i=1, 2, 3, 4, . . . n) to obtain the coordinates in the second image. The result is as shown in FIG. 5A and FIG. 5B. FIG. 5A illustrates the first image 510 and the selected feature points therein, such as feature points 512. In FIG. 5B, the corresponding feature points 522 in the second image 520 can be located according to foregoing calculations.

### Calculating the Intensity Mapping Function

The foregoing step of establishing the homography information between images using a coplanar object in the scene is light performing image registration to the image sequence. The 2D coordinates of a particular point in 3D space on various images can be obtained through homography conversion. Since every image has different exposure, the particular point in 3D space presents different brightness on these images. Thus, an intensity mapping exists between every two images.

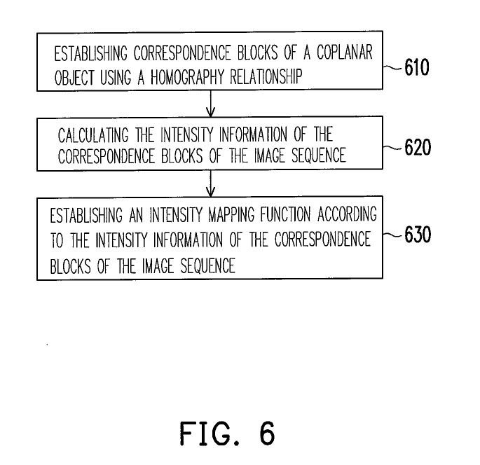

FIG. 6 is a flowchart illustrating the steps for obtaining an intensity mapping function of an image sequence by calculating the intensity information of the image sequence according to an embodiment of the present invention. First, in step 610, the correspondence blocks of a coplanar object are established using a homography relationship. Then, the intensity information of the correspondence blocks of the image sequence in step 620. After that, an intensity mapping function is established according to the intensity information of the correspondence blocks of the image sequence in step 630.

The step of calculating the intensity mapping function between the images includes mainly the 3 steps described above, and which will be described with images Iᵢ and Iⱼ in the image sequence I₁, I₂, I₃, . . . and Iₙ as example. The relationships between other images can be deduced accordingly.

1. Establishing correspondence blocks of a coplanar object between the images.

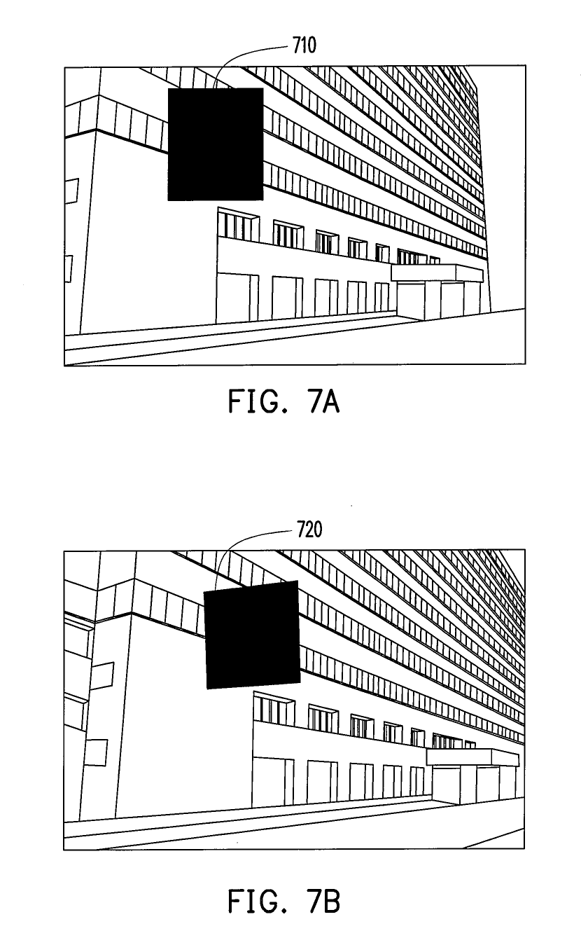

After establishing the homography matrix H between the images Iᵢ and Iⱼ, corresponding coordinates of any point on the coplanar object in image Iᵢ can be found in image Iⱼ, thus, every point on the coplanar object can be used for calculating the intensity mapping function. Accordingly, a region of the coplanar object in image Iᵢ is selected and a corresponding region in image Iⱼ is then located, as the selected region 710 in FIG. 7A and the corresponding selected region 720 in FIG. 7B. The regions may be selected manually or automatically through plane fitting, and the corresponding region can be used for calculating the intensity mapping function between the two images.

2. Calculating the intensity information of the correspondence blocks.

After locating the corresponding regions in image Iᵢ and image Iⱼ, any point in the regions can be used for calculating the intensity mapping function between the two images. However, if the intensity of any point is used directly in the calculation, incorrect correspondence information may be caused easily by quantization or errors in the calculations of correspondence points. Thus, the present embodiment provides a method for calculating a representative value by using information around the point. For example, an average intensity of a mask of 7×7 with a correspondence point as the center is calculated, and the average intensity is used as the intensity value of the correspondence point. Such a method reduces outliers produced in the calculation of the intensity mapping function. In the present embodiment, a mask of 7×7 is used; however, the present invention is not limited thereto, and masks of 4×4, 5×5, and so on may also be used for calculating the average intensity value of a correspondence point.

3. Establishing the intensity mapping function according to the intensity information of the correspondence blocks between the images.

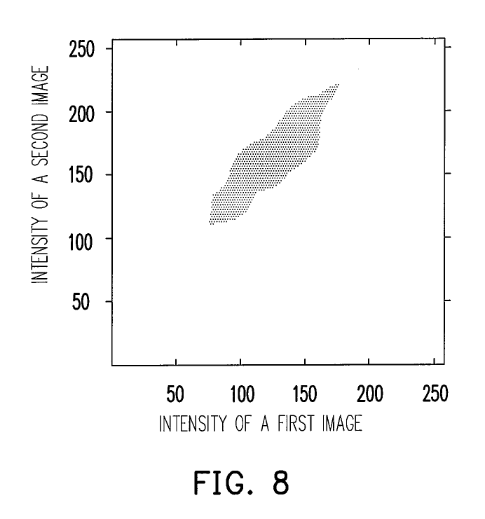

A map is obtained after the intensity information of every point in the correspondence blocks has been established. FIG. 8 illustrates a map of the intensity values of the first image and the second image. The relationship between the intensity value of image Iᵢ and the intensity value of image Iⱼ is shown in FIG. 8, and which is focused on a particular region. This is because that in the present embodiment, a representative value is calculated using the information around each point in the correspondence blocks instead of using the intensity of each point in the images. Accordingly, outliers produced in the calculation of the intensity mapping function can be reduced. It can be understood from FIG. 8 that, the intensity mapping function between images Iᵢ and Iⱼ can be calculated according to the mapping information.

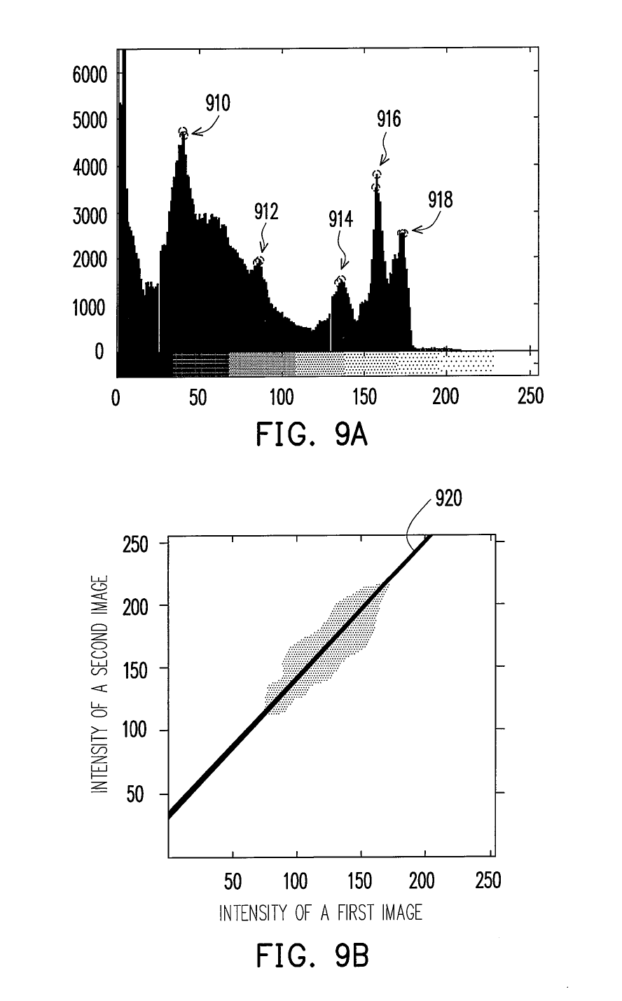

FIG. 9A is diagram illustrating a histogram analysis for calculating an intensity mapping function according to an embodiment of the present invention. According to the histogram analysis method, collected data is categorized into predetermined groups sequentially so as to observe the general data distribution. Generally, the central position, dispersed state, and distribution pattern thereof can be understood. With the intensity histogram information of the correspondence blocks, a higher weight is given to a correspondence point when the intensity of the correspondence point is a peak value in the histogram, such as 910, 912, 914, 916, and 918 in FIG. 9A. After that, the intensity mapping function between images Iᵢ and Iⱼ (for example, the function graph 920 illustrated in FIG. 9B) is then located through estimation, such as robust estimation. The examples for robust estimation are introduced in the article “Numerical Recipes in C: The Art of Scientist Computing (ISBN 0-521-43108-5)”, pages 699-706, all disclosures thereof are incorporated herein by reference.

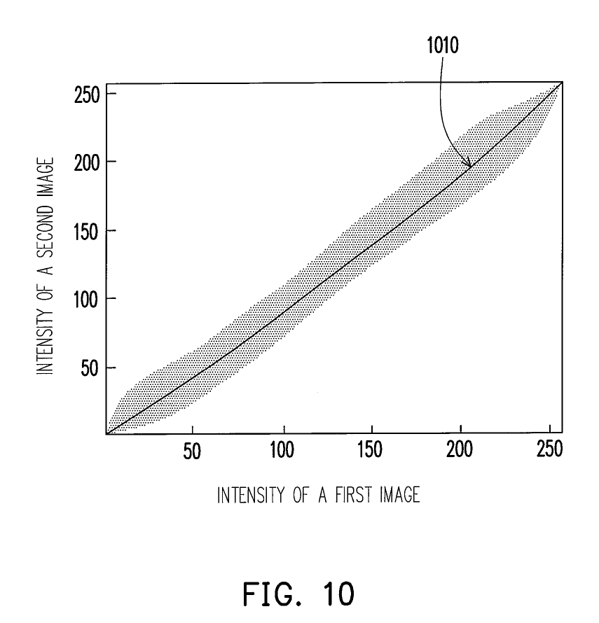

In the article “Radiometric Self-Alignment of Image Sequence” published by Kim, Pollefeys, and so on in 2004, relationships between images of a image sequence is established according to epipolar geometry theory, and the method is applicable to non-static cameras, and furthermore, it is not necessary to assume that the scene is static; however, according to the technique provided by this article, all the points in the images are used for calculating the intensity mapping function, thus, many outliers will be produced while calculating the intensity mapping function. FIG. 10 illustrates an intensity mapping function obtained according to the conventional technique provided by Kim etc. Compared to the result obtained in the present embodiment as illustrated in FIGS. 9A˜9B, the method provided by Kim etc increases complexity in calculation. Besides, since all the points, including incorrect points, are used for calculating the intensity mapping function in this method, the accuracy of the calculation result is reduced.

The method for effectively calibrating a response curve of a non-static camera in the present invention can provide a more accurate result compared to the conventional technique. Moreover, the method in the present invention can be applied to a non-static camera, can be used for capturing an image sequence of various exposures without a tripod, and can be used without assuming a static scene; accordingly, the convenience in using the camera is greatly increased.

Furthermore, according to the method for effectively calibrating a response curve of a non-static camera in the present invention, the homography relationship of an image sequence is calculated by establishing feature correspondence blocks of the image sequence. After that, the intensity mapping function is obtained according to the intensity information of the correspondence blocks, and accordingly a response curve of the camera is obtained. It can be understood from the mapping between the intensity values of the images that the intensity mapping function is focused on a particular region, and this is because that in the present embodiment, the intensity mapping function is not calculated with every point in the images, instead, a representative value in a correspondence block is calculated with information around each point. With this method, outliers produced in the calculation of the intensity mapping function are reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for calibrating a response curve of a camera, the method comprising:
obtaining an image sequence according to a plurality of images captured by various exposures;
selecting a plurality of feature points corresponding to the image sequence, and calculating a homography relationship of the image sequence; and
calculating an intensity mapping function of the image sequence, and calibrating a response curve of the camera according to the intensity mapping function.

2. The calibrating method as claimed in claim 1, wherein the method for calculating the homography relationship of the image sequence comprises:
labeling the feature points of a coplanar object in the image sequence; and
establishing the homography relationship of the image sequence using the feature points.

3. The calibrating method as claimed in claim 2, wherein the method for labeling the feature points of the coplanar object is chosen by a user.

4. The calibrating method as claimed in claim 2, wherein the method for labeling the feature points of the coplanar object is to find the feature points on the coplanar object through plane fitting and feature tracking.

5. The calibrating method as claimed in claim 2, wherein the step of establishing the homography relationship of the image sequence using the feature points comprises projecting the coplanar object on 2D images and then educing the homography relationship from the geometric projection relationship (x′=Hx) of corresponding points in two captured images of the image sequence, wherein x and x′ are the corresponding points in the two captured images.

6. The calibrating method as claimed in claim 1, wherein the step of calculating the intensity mapping function of the image sequence comprises:
establishing a plurality of correspondence blocks of a coplanar object using the homography relationship;
calculating intensity information of the correspondence blocks of the image sequence; and
establishing the intensity mapping function according to the intensity information of the correspondence blocks of at least two captured images in the image sequence.

7. The calibrating method as claimed in claim 6, wherein the step of calculating the intensity information of the correspondence blocks of the image sequence comprises:
calculating a intensity value corresponding to the information within a predetermined value range around each point in each of the correspondence blocks; and
obtaining a map according to the intensity value of each point in the correspondence block, and calculating the intensity mapping function between the two captured images using the map.

8. The calibrating method as claimed in claim 7, wherein the intensity mapping function is calculated through histogram analysis.

9. The calibrating method as claimed in claim 7, wherein in the histogram analysis, weights are given to a plurality of peak values in a histogram correspondingly through robust estimation in order to find out the intensity mapping function.

10. The calibrating method as claimed in claim 1, wherein the step of capturing an image sequence of various exposures is performed by a non-static camera.

11. A method for calibrating a response curve of a camera, the method comprising:
obtaining an image sequence according to a plurality of images captured by various exposures;
establishing a homography relationship of the image sequence using a coplanar object information in the scene;
establishing a correspondence block having a plurality of features in the image sequence according to the homography relationship; and
calculating an intensity mapping function of the image sequence according to an intensity information of the correspondence block, and obtaining a response curve of the camera according to the intensity mapping function.

12. The calibrating method as claimed in claim 11, wherein the method for calculating the homography relationship of the image sequence comprises:
labeling a plurality of feature points of a coplanar object in the image sequence; and
establishing a homography relationship of the image sequence using the feature points.

13. The calibrating method as claimed in claim 12, wherein the method for labeling the feature points of the coplanar object is chosen by a user.

14. The calibrating method as claimed in claim 12, wherein the method for labeling the feature points of the coplanar object is to find out the feature points on the coplanar object through plane fitting and feature tracking.

15. The calibrating method as claimed in claim 12, wherein the step of establishing the homography relationship of the image sequence using the feature points comprises projecting the coplanar object on 2D images and then educing the homography relationship from the geometric projection relationship (x′=Hx) of corresponding points in two captured images of the image sequence, wherein x and x′ are corresponding points in the two captured images.

16. The calibrating method as claimed in claim 11, wherein the step of calculating the intensity mapping function of the image sequence comprises:
establishing the correspondence blocks of the coplanar object using the homography relationship;
calculating intensity information of the correspondence blocks of the image sequence; and
establishing the intensity mapping function according to the intensity information of the correspondence blocks of at least two captured images in the image sequence.

17. The calibrating method as claimed in claim 16, wherein the step of calculating intensity information of the correspondence blocks of the image sequence comprises:
calculating a intensity value corresponding to the information within a predetermined value range around each point in each of the correspondence blocks; and
obtaining a map according to the intensity value of each point in the correspondence block, and calculating the intensity mapping function between the two captured images using the map.

18. The calibrating method as claimed in claim 17, wherein the intensity mapping function is calculated through histogram analysis.

19. The calibrating method as claimed in claim 18, wherein in the histogram analysis, weights are given to a plurality of peak values in a histogram correspondingly through robust estimation in order to find out the intensity mapping function.

20. The calibrating method as claimed in claim 11, wherein the step of capturing the image sequence of various exposures is performed by a non-static camera.
